(19) United States
(12) Patent Application Publication
(10) Pub. No.: US 2021/0062657 A1
(43) Pub. Date: Mar. 4, 2021

(54) CONTROL STAGE BLADES FOR TURBINES

(71) Applicant: General Electric Company, Schenectady, NY (US)

(72) Inventors: Brian Robert HALLER, Rugby (GB); David Mark LITTLEWOOD, Rugby (GB); Philip David HEMSLEY, Rugby (GB)

(21) Appl. No.: 16/557,380

(22) Filed: Aug. 30, 2019

(51) Int. Cl. F01D 5/14; F01D 9/02

(52) U.S. Cl. CPC F01D 5/141; F01D 9/02

(57) ABSTRACT

The present application provides a control stage for a steam turbine. The control stage may include a number of guide blades and a number of runner blades. The number of runner blades may define a ratio of a pitch to a width of about 0.7 to about 1.1.

### TECHNICAL FIELD

The present application and the resultant patent relate generally to axial flow turbines such as steam turbines and the like and more particularly relate to runner blades for the control stage of steam turbines with an expanded pitch and width for improved performance.

### BACKGROUND

Generally described, steam turbines and the like may have a defined steam path that includes a steam inlet, a turbine section, and a steam outlet. Steam generally may flow through a number of turbine stages typically disposed in series through first or control stage blades with guides and runners (or nozzles and buckets) and subsequently through guides and runners of later stages of the steam turbine. In this manner, the guides may direct the steam toward the respective runners, causing the runners to rotate and drive a load, such as an electrical generator and the like. The steam may be contained by circumferential shrouds surrounding the runners, which also may aid in directing the steam along the path. In this manner, the turbine guides, runners, and shrouds may be subjected to high temperatures resulting from the steam, which may result in the formation of hot spots and high thermal stresses in these components. Because the efficiency of a steam turbine is dependent in part on its operating temperatures, there is an ongoing demand for components positioned along the steam or hot gas path to be capable of withstanding increasingly higher temperatures without failure or decrease in useful life. Of significance is improving overall operational flexibility and part-load performance.

Certain turbine blades may be formed with an airfoil geometry. The blades may be attached to tips and roots, where the roots are used to couple the blade to a disc or drum. Depending on the design, the turbine blade geometry and dimensions may result in certain profile losses, secondary losses, leakage losses, mixing losses, and the like that may adversely affect efficiency and/or performance of the steam turbine.

### SUMMARY

The present application and the resultant patent thus provide a control stage for a steam turbine. The control stage may include a number of guide blades and a number of runner blades. The number of runner blades may define a ratio of a pitch to a width of about 0.7 to about 1.1.

The present application and the resultant patent further provide a control stage for a steam turbine. The control stage may include a number of guide blades, a number of runner blades, and a number of platforms. One of the number of runner blades is mounted on each of the number of platforms. The number of runner blades may include a ratio of a pitch to a width of about 0.7 to about 1.1.

These and other features and improvements of this application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a steam turbine with a high pressure section and an intermediate pressure section.

FIG. 2 is a schematic diagram of a control stage of a steam turbine showing a guide blade and a runner blade.

FIG. 3 is a plan view of a pair of runner blades that have been conventionally used in the control stage of FIG. 2.

FIG. 4 is a plan view of a runner blade as described herein with the pair of known runner blades of FIG. 3 superimposed thereon.

FIG. 5 is a plan view of a pair of the runner blades of FIG. 4.

FIG. 6 is a schematic diagram of the runner blade of FIG. 4 positioned in the control stage of FIG. 2.

FIG. 7 is a chart showing Mach number distributions along the runner blade of FIG. 4.

FIG. 8 is a meridional view of the runner blade of FIG. 4 (axial-radial plane).

FIG. 9 is a circumferential view of the runner blade of FIG. 4 (tangential-radial plane).

### DETAILED DESCRIPTION

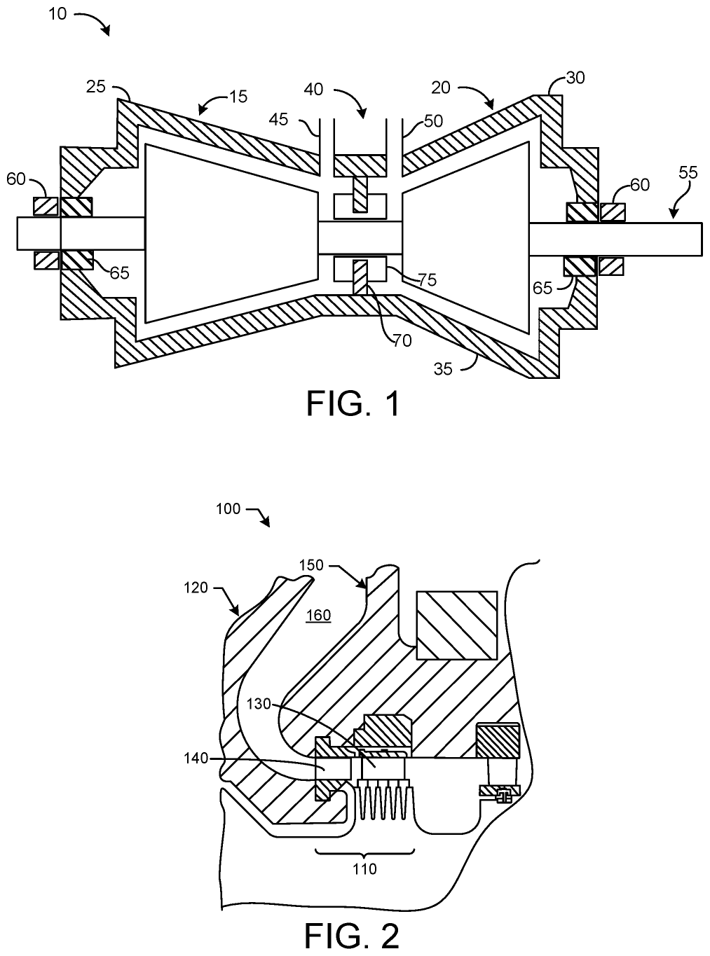

Referring now to the drawings, in which like numerals refer to like elements throughout the several views, FIG. 1 shows a schematic diagram of an example of a steam turbine 10. Generally described, the steam turbine 10 may include a high pressure section 15 and an intermediate pressure section 20. Other pressures and other sections also may be used herein. An outer shell or casing 25 may be divided axially into an upper half section 30 and a lower half section 35. A central section 40 of the casing 25 may include a high pressure steam inlet 45 and an intermediate pressure steam inlet 50. Within the casing 25, the high pressure section 15 and the intermediate pressure section 20 may be arranged about a rotor or disc 55. The disc 55 may be supported by a number of bearings 60. A steam seal unit 65 may be located inboard of each of the bearings 60. An annular section divider 70 may extend radially inward from the central section 40 towards the disc 55. The divider 70 may include a number of packing casings 75. Other components and other configurations may be used.

During operation, the high pressure steam inlet 45 receives high pressure steam from a steam source. The steam may be routed through the high pressure section 15 such that work is extracted from the steam by rotation of the disc 55. The steam exits the high pressure section 15 and then may be returned to the steam source for reheating. The reheated steam then may be rerouted to the intermediate pressure section inlet 50. The steam may be returned to the intermediate pressure section 20 at a reduced pressure as compared to the steam entering the high pressure section 15 but at a temperature that is approximately equal to the temperature of the steam entering the high pressure section 15. Accordingly, an operating pressure within the high pressure section 15 may be higher than an operating pressure within the intermediate pressure section 20 such that the steam within the high pressure section 15 tends to flow towards the intermediate section 20 through leakage paths that may develop between the high pressure 15 and the intermediate pressure section 20. One such leakage path may extend through the packing casing 75 about the disc shaft 55. Other leaks may develop across the steam seal unit 65 and elsewhere.

FIG. 2 shows a schematic diagram of a portion of a steam turbine 100 including a first or a control stage 110 of a high pressure section 120. The control stage 110 may have a number of rotating runner blades 130 and a number of static guide blades 140. The control stage 110 further may be provided with a valve assembly (not shown) that controls the flow of steam through the runner blades 130 and through the guide blades 140. Steam enters the steam turbine 100 through supply lines provided with master valves to turn the total high pressure steam supply on or off and/or to throttle the supply as appropriate. Specifically, the steam turbine 100 may have a partial arc admission configuration 150. In such a configuration, a number of smaller valves may be provided to control the steam input to a number of different steam inlet passages 160 (one of which is shown). Any number of downstream stages also may be used. Other components and other configurations may be used herein.

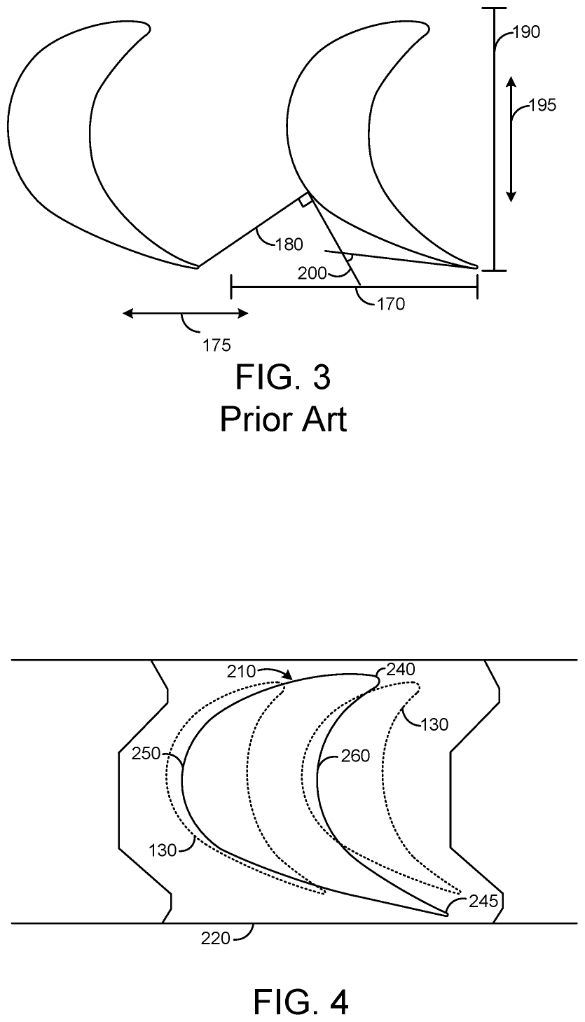

As is shown in FIG. 3, the runner blades 130 may have a pitch 170, a throat 180, a width 190, and a back surface deflection angle 200. The pitch 170 may be defined as the distance in a circumferential or tangential direction 175 between corresponding points on adjacent runner blades 130. The throat 180 may be defined as the shortest distance between surfaces of adjacent runner blades 130. The width 190 may be the width of the blade 130 in an axial direction 195. The back surface deflection angle 200 may be defined as the “uncovered turning” angle, i.e., the change in angle between a suction surface throat point and a suction surface trailing edge blend point. Other embodiments may have different sizes, shapes, and configurations.

Referring to FIG. 4, an example of an improved runner blade 210 as may be described herein is shown as positioned on a standard root platform 220. Two conventional runner blade 130 are superimposed thereon in dashed lines for purposes of comparison. The runner blade 210 includes a leading edge 240, a trailing edge 245 opposite the leading edge 240, a suction side 250 extending between the leading edge 240 and the trailing edge 245, and a pressure side 260 opposite the suctions side 250 and extending between the leading edge 240 and the trailing edge 245.

As can be seen, the improved runner blade 210 may have a greater width 190 and about twice the pitch 170 as compared to the known conventional runner blades 130. As a result, a given stage may have about half the number of runner blades with each root platform 220 having only one runner blade 210 instead of the conventional two blades 130. Moreover, the runner blade 210 may be attached to the root platform 220 with two sets of pinholes (not shown) to provide improved resistance to tangential bending as compared to the use of a single set.

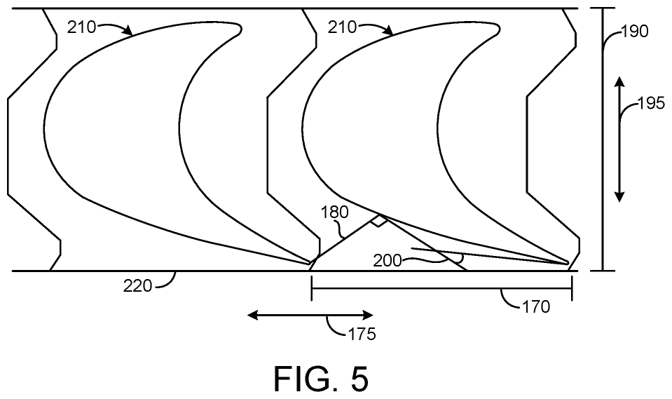

More specifically as is shown in FIG. 5, the runner blade 210 may have a ratio of a pitch 170 to a width 190 at the root thereof of about 0.7 to about 1.1 with a pitch to width ratio of about 0.94 preferred (plus or minus 0.1). Existing conventional designs have a ratio of less than about 0.6. Using such a design with the higher pitch to width ratio results in significant non-intuitive improvements in aerodynamic performance. Specifically, profile losses are reduced for all sections of the runner blade 130 (root, mean, and tip).

Likewise, the back surface deflection angle 200 may be higher than found in conventional blades to reduce further profile and secondary flow losses. The back surface deflection angle 200 thus may be about 28 degrees to about 38 degrees with about 33.6 degrees preferred (plus or minus a degree). Existing designs may not include a convergent passage or may have an angle of about 11 degrees or less.

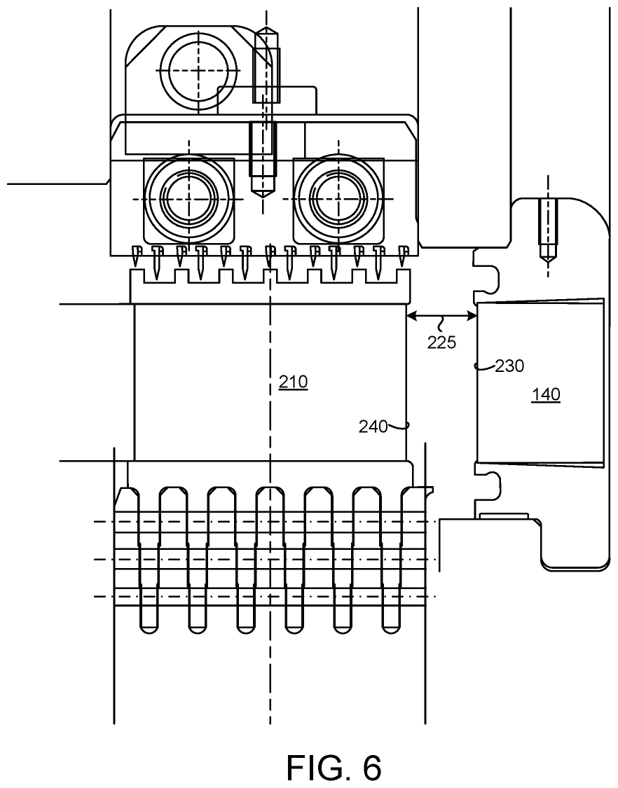

As is shown in FIG. 6, an interspace axial gap 225 between a trailing edge 230 of a guide blade 140 and an adjacent leading edge 240 of the runner blade 210 may be about 20% to about 30% of the runner blade axial width 190 at the root, with a gap of about 25% preferred (plus or minus 1%). Conventional designs may be in the range of about 15% or less. The ratios and percentages of the improved runner blade 210 described herein are valid over a wide range of absolute physical dimensions.

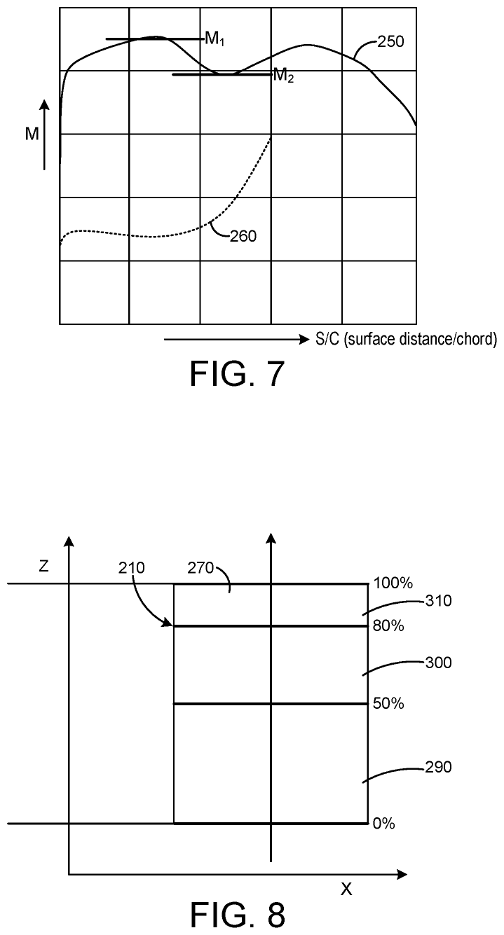

As can be seen in FIG. 7, the design of the improved runner blade 210 produces a “double hump” type of pressure distribution on the suction side 250 of the runner blade 210 due to the high curvature changes as represented by line 360. Again, such a pressure distribution of diffusion followed by acceleration may be considered non-intuitive given that conventional runner blade arrangements produce a pressure distribution of acceleration followed by gradual diffusion. As a result, the Mach ratio M₁/M₂ (high Mach number/low Mach number) along the perimeter of the blade 210 may be about 1.05 to about 1.3 with about 1.18 preferred (plus or minus 0.1). The pressure distribution for the pressure side 260 also is shown as line 360. The runner blade 210 may feature an inconsequential amount of diffusion on the leading edge 240 of the pressure side 260 to increase acceleration on the suction side 250. Surprisingly, inlet choking, i.e., shock, at part-load conditions essentially disappeared. Partial loads down to about fifteen percent thus may be accommodated.

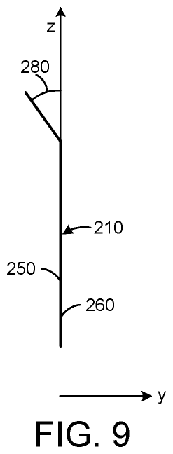

As can be seen in FIGS. 8 and 9, the runner blade 210 also may include an angled tip 270 at an end thereof. The angled tip 270 may have a tip lean 280 towards the suction side 250 of about 20 degrees to about 30 degrees with about 25 degrees preferred. The tip lean 280 may start at about 70 percent to about 90 percent of the length of the blade with about 80 percent preferred (plus or minus 1 percent), i.e., the runner blade 210 extends from a root 290 to a main portion 300 to a tip 310. The tip lean 280 may promote further reduced secondary tip losses. Specifically, the tip lean 280 may introduce radial body forces on the flow that may be counteracted by an increase in the static pressure on the tip endwall, i.e., lower velocities and hence lower losses. Other angles and other configurations may be used herein.

The improved runner blade 210 thus may improve overall efficiency while reducing possible component damage and/or failure. Specifically, the improved runner blade 210 may reduce overall centrifugal forces as well as root bending stresses and the like in a surprising and non-intuitive design with improved mechanical and aerodynamic features.

It should be apparent that the foregoing relates only to certain embodiments of this application and resultant patent. Numerous changes and modifications may be made herein by one of ordinary skill in the art without departing from the general spirit and scope of the invention as defined by the following claims and the equivalents thereof.

We claim:

1. A control stage for a steam turbine, comprising:
a plurality of guide blades; and
a plurality of runner blades;
the plurality of runner blades defining a ratio of a pitch to a width of about 0.7 to about 1.1.

2. The control stage of claim 1, wherein the ratio of the pitch to the width is about 0.94.

3. The control stage of claim 1, wherein each runner blade of the plurality of runner blades comprises a back surface deflection angle of about 28 degrees to about 38 degrees.

4. The control stage of claim 3, wherein the back surface deflection angle comprises about 33.6 degrees.

5. The control stage of claim 1, wherein a trailing edge of a first guide blade of the plurality of guide blades and an adjacent leading edge of a first runner blade of the plurality of runner blades comprises an interspace axial gap therebetween.

6. The control stage of claim 5, wherein the interspace axial gap comprises between about 20% to 30% of the width of the first runner blade.

7. The control stage of claim 6, wherein the interspace axial gap comprises about 25% of the width of the first runner blade.

8. The control stage of claim 1, wherein the plurality of runner blades comprises a Mach ratio along a perimeter of each runner blade of about 1.05 to about 1.3.

9. The control stage of claim 8, wherein the Mach ratio along the perimeter of each runner blade is about 1.18.

10. The control stage of claim 1, further comprising a platform and wherein one of the plurality of runner blades is positioned on the platform.

11. The control stage of claim 1, wherein each of the plurality of runner blades comprises a root, a main portion, and a tip.

12. The control stage of claim 11, wherein the tip comprises a tip lean.

13. The control stage of claim 12, wherein the tip lean comprises about 20 degrees to about 30 degrees.

14. The control stage of claim 12, wherein the tip lean comprises about 25 degrees.

15. The control stage of claim 1, further comprising a partial arc admission configuration.

16. A control stage for a steam turbine, comprising:
a plurality of guide blades;
a plurality of runner blades; and
a plurality of platforms;
one of the plurality of runner blades is mounted on each of the plurality of platforms;
the plurality of runner blades comprising a ratio of a pitch to a width of about 0.7 to about 1.1.

17. The control stage of claim 16, wherein each runner blade of the plurality of runner blades comprises a back surface deflection angle of about 28 degrees to about 38 degrees.

18. The control stage of claim 16, wherein a trailing edge of a first guide blade of the plurality of guide blades and an adjacent leading edge of a first runner blade of the plurality of runner blades comprises an interspace axial gap therebetween and wherein the interspace axial gap comprises between about 20% to 30% of the width of the first runner blade.

19. The control stage of claim 16, wherein the plurality of runner blades comprises a Mach ratio along a perimeter of each runner blade of about 1.05 to about 1.3.

20. The control stage of claim 16, wherein each of the plurality of runner blades comprises a tip with a tip lean of about 20 degrees to about 30 degrees.
